(19) United States
(12) Patent Application Publication
(10) Pub. No.: US 2011/0024665 A1
(43) Pub. Date: Feb. 3, 2011

(54) VALVE

(75) Inventor: Elias Hajjar, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MTA House, Level 1, 43-51 Brisbane Street

(21) Appl. No.: 12/867,029

(22) PCT Filed: Feb. 11, 2009
(86) PCT No.: PCT/AU09/00156

§ 371 Date: Oct. 12, 2010

(30) Foreign Application Priority Data
Feb. 11, 2008 (AU) 2008900640
Feb. 29, 2008 (AU) 2008901011

(51) Int. Cl. F16K 1/42

(52) U.S. Cl. 251/359

(57) ABSTRACT

A valve device (1) which includes a fluid inlet (4) a fluid outlet (5), a main valve seat (32) defining an aperture through which fluid may selectively flow from said inlet (4) to said outlet (5), a valve assembly (31), movable relative to said main valve seat (32) between an open position of said valve in which fluid may flow from said inlet (4) to said outlet (5), and, a closed position of said valve in which fluid flow is prevented, a control chamber (12), at least a portion of the wall of which is formed by said valve assembly (31), such that the volume of said control chamber (12) is variable depending upon the position of said valve assembly (31), a fluid passageway (7), providing fluid communications between said fluid inlet (4) and said control chamber (12).

### BACKGROUND OF THE INVENTION

The present invention relates to a valve device, and in particular to a hydraulically assisted valve device. The valve device of the present invention provides significant advantages over prior art valve devices in that a considerably smaller actuating member displacement than that of prior art devices is sufficient to operate the valve. This, in a solenoid operated valve, results in significantly lower operational power requirements.

### DESCRIPTION OF THE PRIOR ART

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

The applicant has previously invented various valve devices which have improvements and modification over the prior art. One such device, which utilises a flow control element such that microscopic flows only are required to activate the valve, is described in the applicant's earlier international patent application of the PCT/AU96/00263. The entire disclosures of this document should be considered to be incorporated herein by this reference thereto. The applicant has hereinbefore also previously invented various other valve devices for which various other patent applications have also been filed in the name of Microflow Pty Ltd.

Whilst the applicant's earlier inventions have considerable improvements over traditional prior art devices, in that only microscopic flows are required to operate the valve, the applicant has invented further improvements and modification to such valves, as hereinafter described.

FIG. 1 and FIG. 2 show the most common arrangements known to be used in hydraulically assisted valves. In general, lowering the actuation power depends on the shortest distance by which the valve members need to move under the influence of the actuating power for achieving the required flow.

FIG. 1 illustrates an arrangement of hydraulically assisted valves which the industry continues to adopt for controlling flow rates approximately less than 50 L/min. (the industry in general adopts this arrangement because the by pass flow rate requires slightly less axial plunger movement than that needed to establish the required main flow.

FIG. 2 illustrates an arrangement of a hydraulically assisted valve which the industry adopts for controlling flow rates that are approximately greater than 50 L/min.

It should be noted that, in FIG. 1, the axial movement of the relief valve member 2 is equal to the axial movement of the main valve member 3 plus the axial movement needed to open the relief port. That is the actuation power of this arrangement largely depends on the relief port cross-section as well as the displacement of the main valve member 3. In such instance, the extent of lowering the actuation power by adopting the cascading arrangement of FIG. 2 is relatively too insignificant to justify the additional complications such arrangements represent. However, the additional power that would be associated with the relatively large displacement needed to control larger flow rates becomes significant enough to necessitate/justify the use of arrangements such as that of FIG. 2

Unlike the arrangement of FIG. 1 the displacement of the main valve member 2 in FIG. 2 has no direct effect on the actuation power. That is, the actuation power in this case depends only on the relief port cross section and the smaller displacement of the relief valve (not the main valve member) member displacement.

### SUMMARY OF THE INVENTION

The present invention seeks to overcome some of the disadvantages of the prior art.

The present invention seeks to provide an improved valve device in which the power required to actuate the valve is reduced.

The present invention also seeks to provide an improved valve device in which the relatively large displacement of the main valve member has no direct effect on the actuation power.

In one broad form, the present invention provides a valve device including:
a fluid inlet;
a fluid outlet;
a main valve seat defining an aperture through which fluid may selectively flow from said inlet to said outlet;
a valve assembly, movable relative to said main valve seat between an open position of said valve in which fluid may flow from said inlet to said outlet, and, a closed position of said valve in which fluid flow is prevented;
a control chamber, at least a portion of the wall of which is formed by said valve assembly, such that the volume of said control chamber is variable depending upon the position of said valve assembly;
a fluid passageway, providing fluid communications between said fluid inlet and said control chamber; and
control means, to control the position of said relief valve member relative to said valve body of said valve assembly, and thereby, to control the movement of said valve assembly relative to said valve seat between said open and closed positions

Preferably, said valve assembly includes:
a valve body, including a relief inlet, a relief valve seat defining a relief outlet, and an internal cavity; and
a relief valve member, movable within said internal cavity of said valve body between a first position whereby said relief valve member is moved apart from said relief valve seat such that fluid may flow from said relief inlet to said relief outlet, and, a second position whereby said relief valve member abut said relief valve seat to prevent fluid flow through said relief outlet.

Preferably, wherein said control means includes any one or combination of an electrical, mechanical, electromagnetic or other control means capable of initiating movement of said relief valve member relative to said valve body of said valve assembly.

Also preferably, wherein said relief member is at least partly formed of resilient material such as to normally bias said relief valve member into either of said first or said second position.

In a preferred form, wherein said relief valve member is normally biased into said second (closed) position and, the open said valve, said control means is activated to move said relief valve member away from said relief valve seat to initiate flow of fluid from said relief inlet to said relief outlet, whereby, once said flow is initiated, a change in fluid pressure assists movement causes said valve assembly to move away from said valve seat to open said valve and permit fluid to flow from said fluid inlet to said fluid outlet.

In another preferred form, wherein said relief member is normally biased into said first (open) position and, to close said valve, said control means is activated to move said relief valve towards said relief valve seat to prevent flow of fluid from said relief inlet to said relief outlet, whereby, once said flow is prevented, a change in fluid pressure effects said valve assembly to move against said valve seat to close said valve and prevent flow of fluid from said fluid inlet to said fluid outlet.

Preferably, wherein said relief valve member includes at least one protrusion and preferably a plurality of protrusions, formed of resilient material, extending into contact with said valve body of said valve assembly, so as to bias said relief valve member relative to said valve body.

Also preferably, the device further includes:
a flow control element provided within said fluid passageway, to restrict the flow of fluid within said fluid passageway and substantially prevent the ingress of dirt or like particles from entering said fluid passageway and, if any does, the relative movement of said flow control element within said passageway cats to expel such particles from within said passageway.

In a further broad form, the present invention provides a valve device arrangement including:
a valve seat defining an aperture through which fluid may flow when said valve device is in an open position; and,
a valve member adapted to move relative to said valve seat between, an open position whereby said valve member is at least partly displaced from said valve seat, and, a closed position whereby said valve member abuts said valve seat to prevent the flow of fluid through said aperture;
characterised in that, at least the extremities of said valve seat is formed of resilient material enabling at least some compression or deformation of said valve seat (to provide improved sealing between said valve seat and said valve member).

Preferably, whereby movement of said valve member relative to said valve seat is any one or combination of translational, rotational, sliding pivotal, axial or other directional movement.

In another broad form, the present invention provides a valve component, adapted to be movably housed within a valve body between a first position whereby said valve component is moved apart from a valve seat, and a second position whereby said valve device abuts said valve seat, including at least one protrusion, and preferably a plurality of protrusions, formed of resilient material, extending into contract with said valve body so as to bias said valve component into at least one of said first or second positions relative to said valve body.

### BRIEF DESCRIPTION OF THE DRAWINGS

The present invention will become more fully understood from the following detailed description of preferred but non limiting embodiments thereof, described in connection with the accompanying drawings, in which:

FIG. 1 shows, in FIGS. 1(a) and 1(b) a prior art valve device;

FIG. 2 shows a prior art cascaded valve device;

FIG. 3 illustrates a preferred embodiment of the valve device in accordance with the present invention;

FIG. 4 illustrates the valve assembly (labelled 31) of the valve device of FIG. 3 in a closed state, FIG. 4(a) illustrates a sectional view along line A-A;

FIG. 5 illustrates the valve device of FIG. 4 but in the open state;

FIG. 6 illustrates an alternatively preferred embodiment of a valve assembly to that of FIG. 4, FIG. 6 showing this embodiment of the valve assembly in its open state;

FIG. 7 illustrates the closed state of the valve of FIG. 6;

FIG. 8 illustrates a schematic view of a generalised valve device in accordance with the present invention;

FIG. 9 illustrates, in FIGS. 9a, 9b and 9c thereof, an alternative arrangement of a valve showing, in FIG. 9a the closed position of the valve assembly, FIG. 9b showing the just actuated position of the valve, and FIG. 9c illustrates the fully open position of the valve;

FIG. 10 illustrates a valve seat arrangement, FIG. 10a illustrating a prior art arrangement of a valve seat, FIG. 10a illustrating the prior art closed position and FIG. 10b illustrating the prior art open position of the conventional valve assembly arrangement;

FIG. 11 illustrates an arrangement of a valve seat in accordance with the present invention,

FIG. 11a illustrating the initial state of the valve seat, FIG. 11b illustrating the closed state of the valve seat, and FIG. 11c illustrating the open state of the valve seat in accordance with the present invention; and

FIG. 12 illustrates an alternatively preferred arrangement of a valve seat in accordance with the present invention, FIG. 12a illustrating the closed position of the valve seat and FIG. 12b illustrating the open position of the valve seat.

### DETAILED DESCRIPTION OF THE PREFERRED EMBODIMENTS

Throughout the drawings, like numerals will be used to identify like features, except where expressly otherwise indicated.

It should be initially recognised that the present invention may relate to the Applicant's earlier invention, which is the subject of International Patent Application No. PCT/AU96/00263. Parts of or the entire disclosures of this earlier patent application may (but not necessary) be considered to be incorporated herein by this reference thereto.

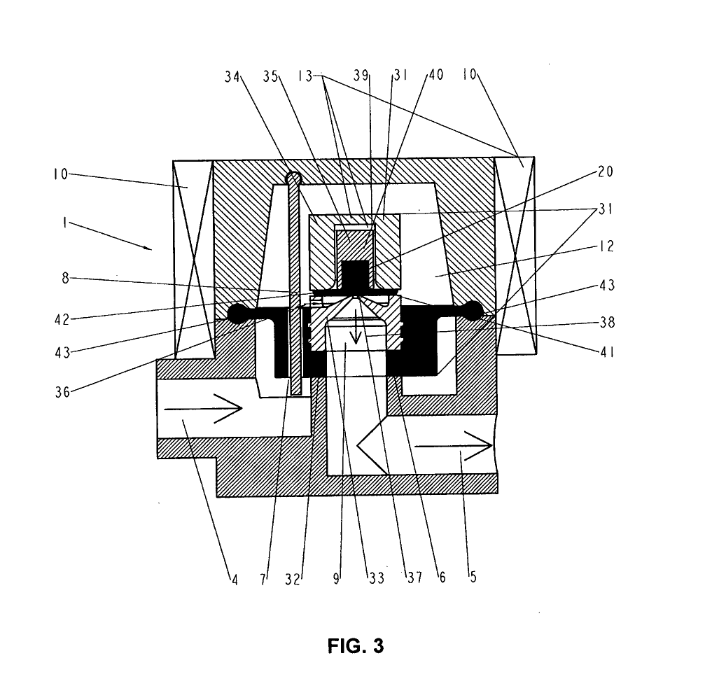

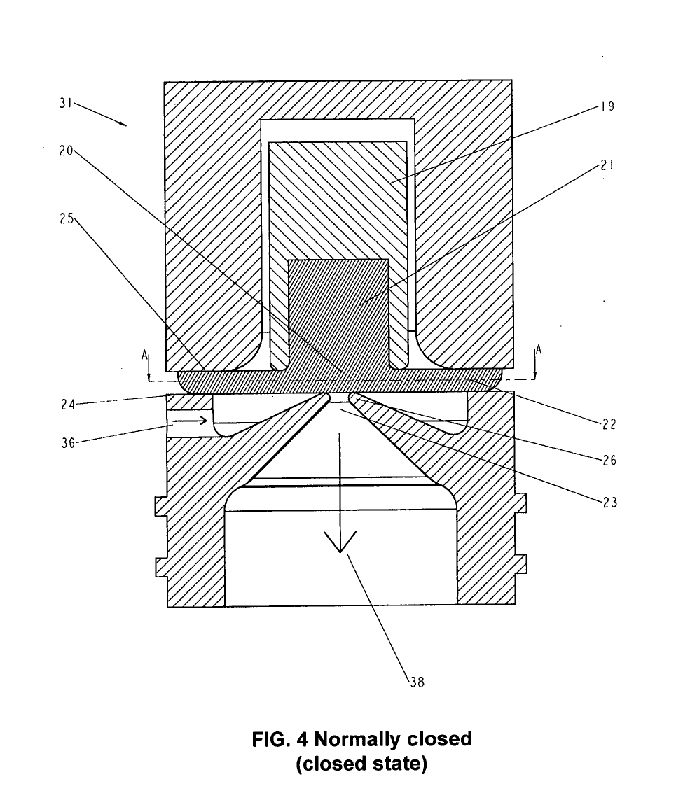

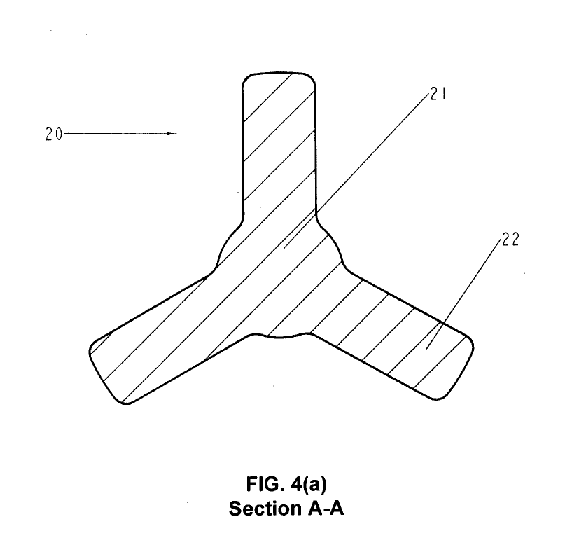

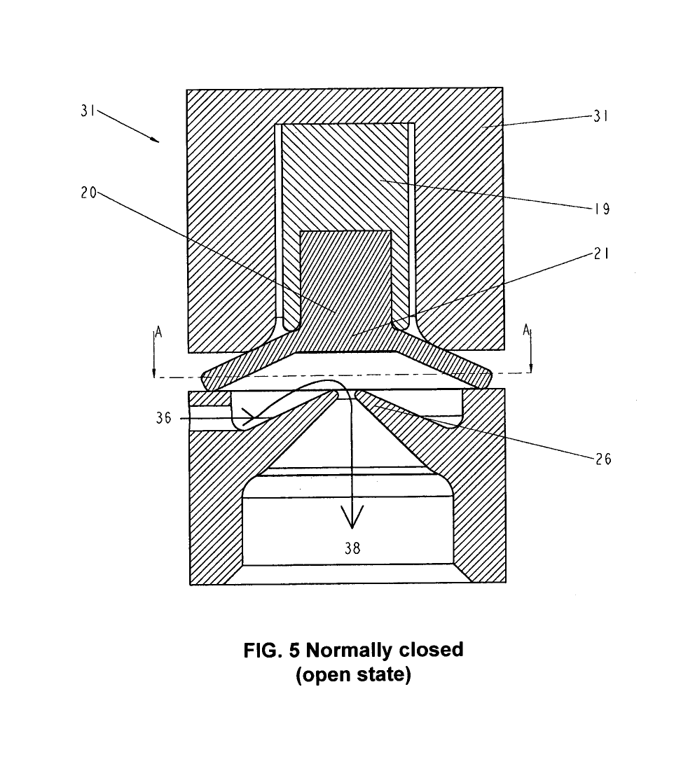

FIG. 3 shows a valve device, generally designated by the numeral 1 having a fluid inlet 4, a fluid outlet 5, a main valve seat 32 and a valve assembly, generally designated by the numeral 31. It will be understood that the entire valve assembly 31 may be moved relative to the valve seat 32 such that fluid can flow from the inlet 4 to the outlet 5. The valve assembly, generally designated by the numeral 31, can be seen in FIG. 3 as including a first body member 33, a second body member 34, and a relief valve member 35 positioned therebetween. The first body member 33 of the valve assembly 31 includes a relief inlet 36, a relief valve seat 37 defining a relief outlet 38. The second part 34 of the valve assembly has an internal cavity 39 in which the relief valve member 40 is provided. The valve assembly 31, while shown as being made of two parts 33 and 34 may be formed of one part, or many parts, which may be sandwiched between said main valve seat 32 and a spring like electrically conducting biasing means, depending upon the mode of manufacture. These may be manufactured from plastics metal or other suitable material. The relief valve member 40 which is positioned within the cavity 39 of these valve parts 33 and 34 is adapted to move within the cavity 39, during use. The relief valve member 40 is preferably at least partially formed of a resilient material. In particular, the lower portion 41 which has protrusions 42 extending therefrom is preferably formed of resilient material such that it assumes a normal position, and can undergo deformation. Details of the type of deformation which may be undergone as shown in FIGS. 4 and 5.

FIG. 4 illustrates the closed state of the valve assembly portion 31 of the valve device 1 of FIG. 3, whilst FIG. 5 illustrates the open state of the valve of FIG. 4. As shown in FIG. 4, the closed state is whereby the resilient member 20 is relaxed such that its central region 21 abuts the valve seat 26, consequently preventing flow from the inlet 36 to the outlet 38. FIG. 4(a) illustrates a sectional view along line A-A of FIG. 4.

FIG. 5 illustrates the resilient member 20 having been deformed such that the central region 21 is withdrawn away from the valve seat 26 such that fluid flow is permitted from the inlet 36 to the outlet 38. Activation of the valve assembly 31 to effect movement of the valve member 19 from the position shown in FIG. 4 to the position shown in FIG. 5 will be described hereinafter.

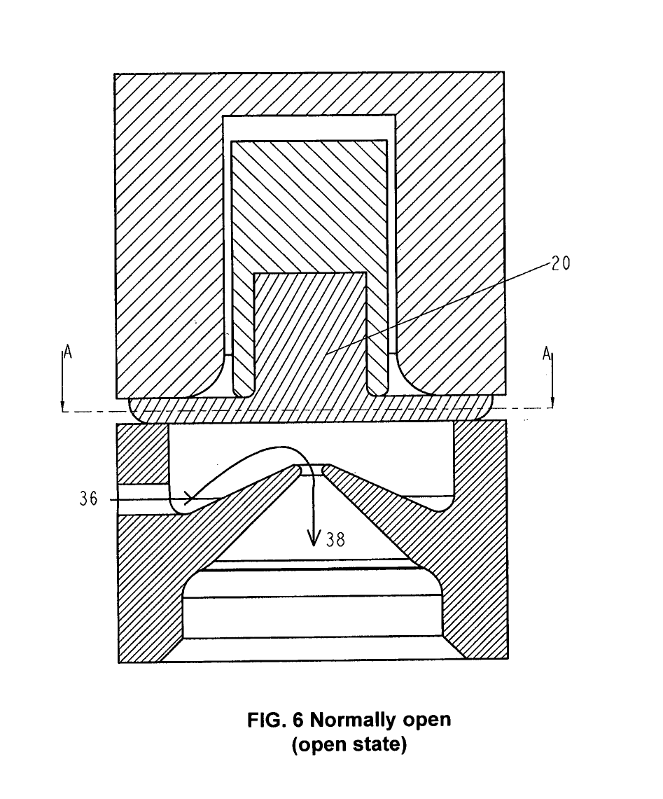

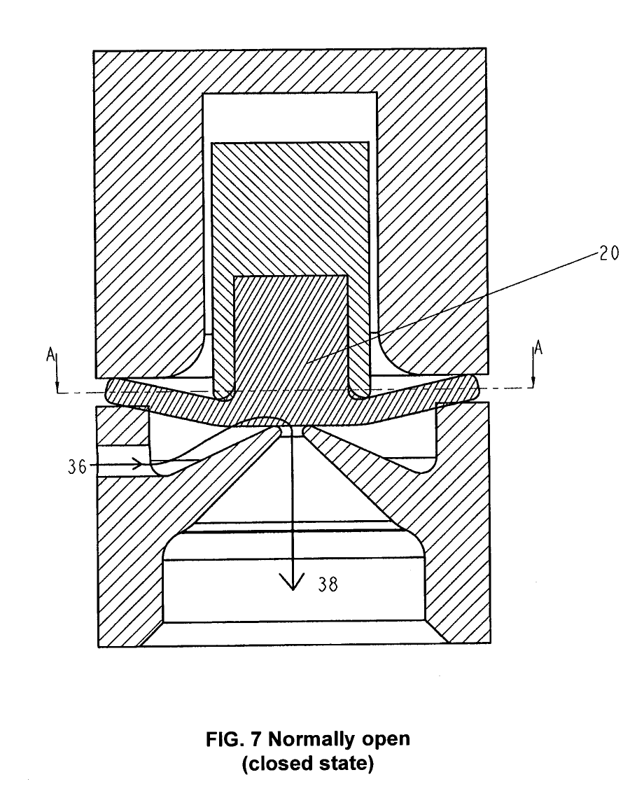

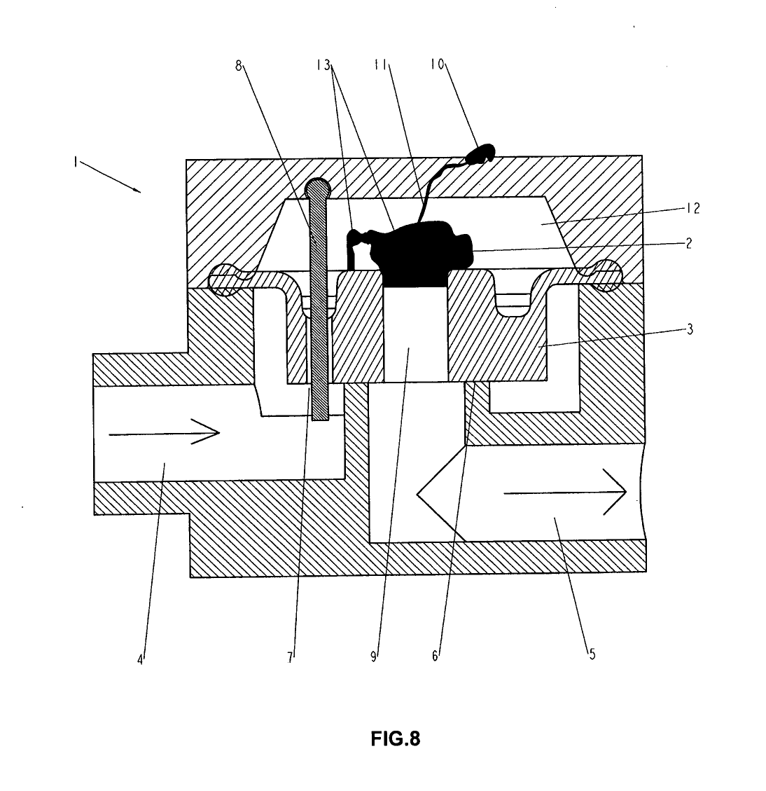

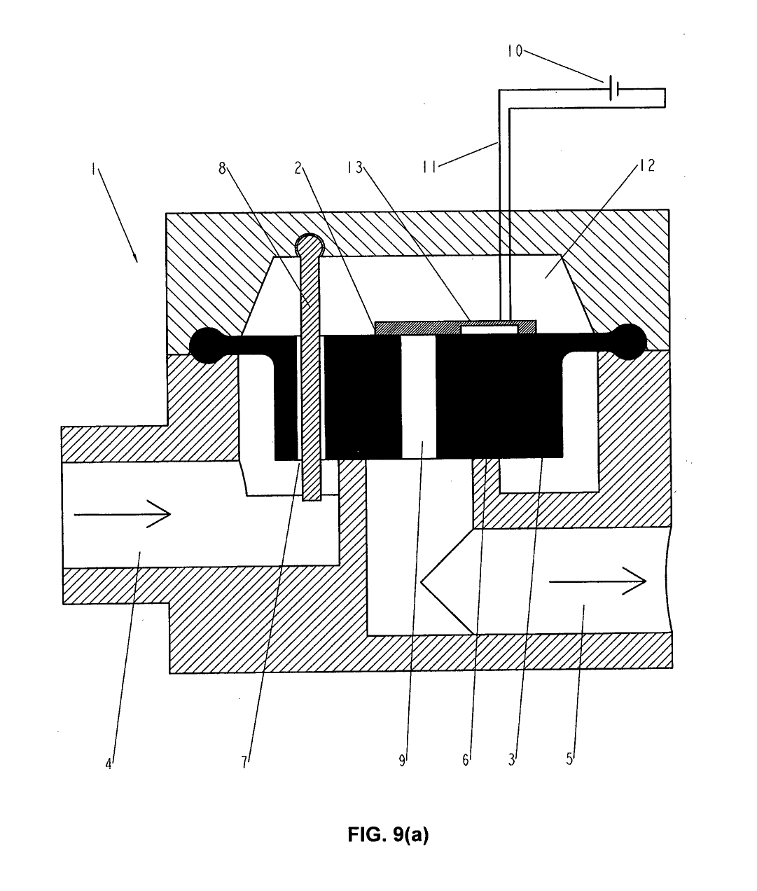

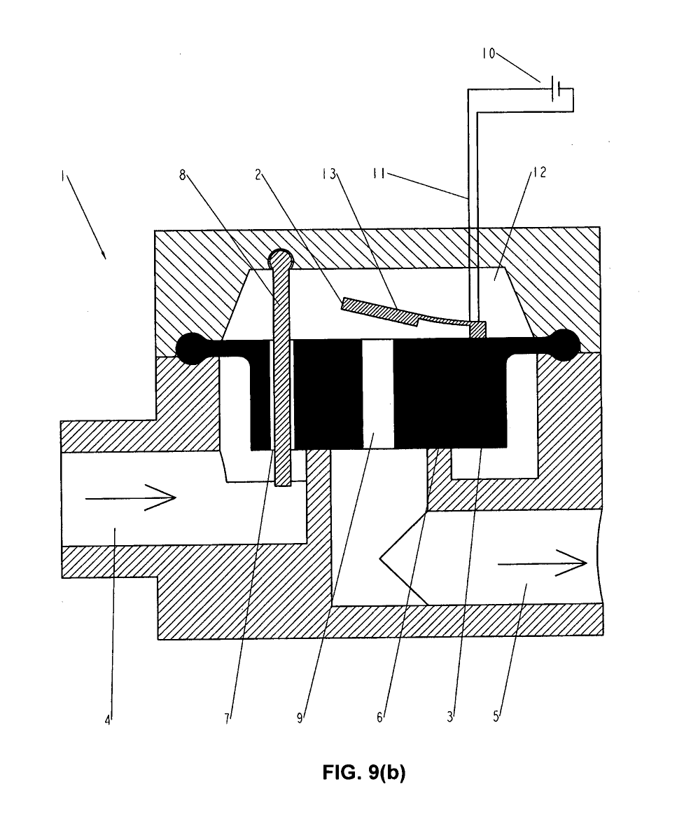

FIG. 6 illustrates an alternatively preferred embodiment wherein the valve is normally open in the relaxed state of the resilient member 20 such that fluid flow is permitted from the inlet 36 to the outlet 38, whilst FIG. 7 illustrates the closed state of the valve assembly of FIG. 6 wherein the resilient member 20 is in a deformed state consequently blocking flow from the inlet 36 to the outlet 38.

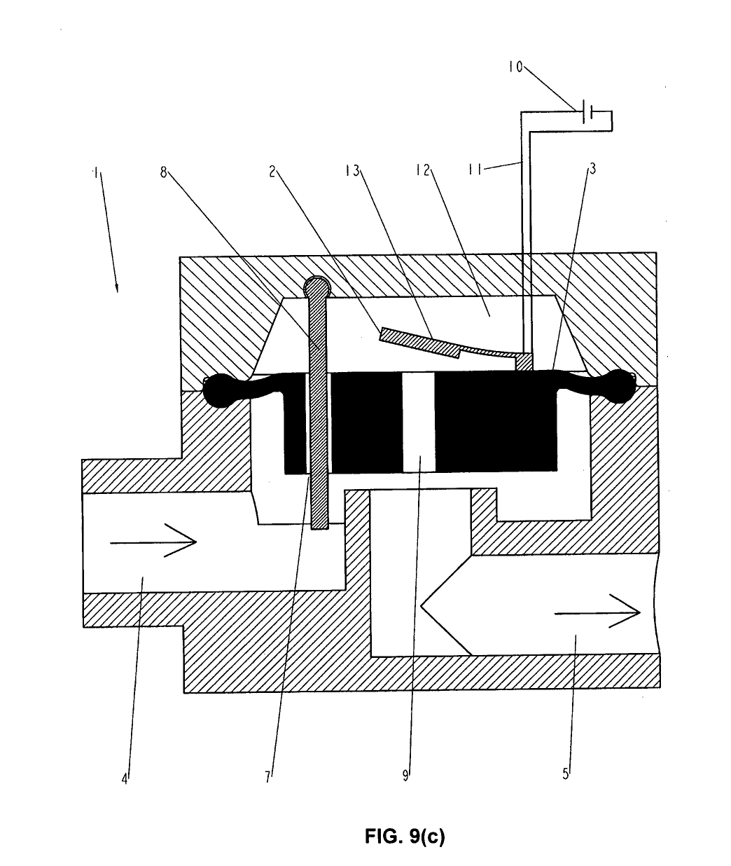

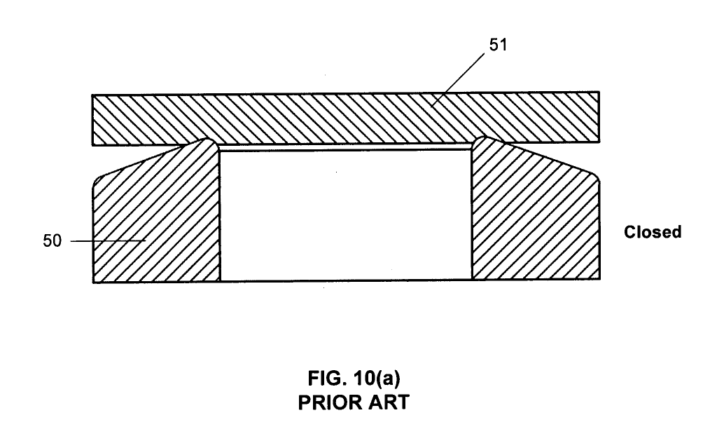

It will be appreciated that, as shown in FIG. 4(a), the resilient member 20 may have a central region 21 and a plurality of arms 22. It will be appreciated that one arm, or a plurality of arms may be provided although three such arms are shown in FIG. 8. It should be noted that the resilient member 20 may be used with or separately from the valve device described in this specification.

Referring back to FIG. 3, also shown is a control chamber 12 whereby at least a portion of the wall of which is formed by the valve assembly 31, such that the volume of the control chamber 12 is variable depending upon the position of the valve assembly 31. A fluid passageway 7 provides fluid communication between the fluid inlet 4 and the control chamber 12 also shown is a control means, in the form of a solenoid 10, which controls the position of the relief valve member 40 relative the valve body 34 of the valve assembly 31, to thereby control the movement of the valve assembly 31 relative to the valve seat 32 between its open and closed positions.

It will be appreciated that the control means 10 may be an integral part of said second body member 34 (as in the case of FIG. 9) and/or any one or combination of an electrical, mechanical, electromechanical or other control means capable of initiating movement of the relief valve member 40 relative to said relief valve seat 37 of the valve assembly 31. In use, it will be appreciated that by utilizing a small amount of power to activate the solenoid 10, the relief valve member 40 may be moved slightly away from the valve seat 37 such that a small amount of fluid may flow from the inlet 36 to the outlet 38. Once this fluid flow occurs, which is permitted due to the fluid passageway 7, the pressure in chamber 12 reduces. Because of the reduced pressure in chamber 12 (the chamber 12 having at least part of its wall being formed by the wall of a valve assembly 31) the valve assembly 31 therefore moves away from the valve seat 32. It will be noted that there is a diaphragm like arrangement 43 to ensure that good seal is enabled between the control chamber and the inlets and outlets. It will therefore be appreciated that a small flow of fluid through the relief valve portion formed by the flow of fluid through the passageways 7, 36 and 38 is enough to initiate movement of the valve assembly 31 from its closed to open position.

Likewise, to close the valve, the solenoid 10 may be deactivated such that the resilient member 20 (FIG. 3) moves and abuts the valve seat 37 such that fluid flow between the inlet 36 and outlet 37 is thereby prevented. When this occurs, the fluid pressure in chamber 12 again changes and returns to equalize the pressure in the inlet 4, as it is effectively opened by fluid passageway 7. This increase pressure in chamber 12 consequently forces the valve assembly 31 to again close against the valve seat 32, consequently closing operation of the valve 1.

FIG. 8 illustrates a more generalized version of the valve arrangement of the present invention again showing the inlet port 4, the outlet port 5 and the control chamber 12. The intention of this illustration is to show that a wide variety of different shaped, positioned, etc. components may be utilized to achieve the functional operation of this invention. In essence, it shows that the position of valve member 3 is controlled by signaling a power source 10 to actuate a release valve segment 13 by delivering the required amount of power via a power linkage 11. FIG. 8 illustrates the valve 1 in the closed position in which the state of the relief valve segment 13 is altered in a manner which causes or allows the relief valve member 2 to block relief port 9 such that the valve member 3 rests against the valve seat 6 whereby fluid is effectively prevented from flowing from the fluid inlet 4 to the fluid outlet 5.

The flow control element 8, as shown in FIG. 3, is provided in the fluid passageway 7, to restrict the flow of fluid through the fluid passageway such that only an extremely small amount of fluid can therefore flow through the passageway 7. The flow control element furthermore effectively substantially prevents the ingress of dirt or like particles from entering the fluid passageway 7, and if any does, the relative movement of the flow control element 8 within the passageway 7 of the valve member 3, acts to remove or expel such particles from within the passageway 7. This self cleaning operation has significant advantages over the prior art devices which are prone to blockage. This flow control element is more fully explained in the Applicant's other patent applications.

The flow control element 8 may be retained in its optimal position by being attached to the wall of the control chamber 12 as shown in FIG. 3, but those skilled in the art will appreciate that it may be otherwise retained in position by, for example, being attached to the valve member 3. The flow control element may be embodied as a rigid rod, formed with metal or like material, and should be selected such that its cross-sectional area is slightly smaller than the cross-sectional area of the fluid passageway 7 into which it is received, such that a very small flow of fluid therearound is permitted to flow. This therefore provides the desired fluid flow restrictive properties. In manufacture of the fluid passageway, an appropriately sized orifice can be readily formed, and then, in use, the amount of fluid flowing through the passageway 7 can be limited by installing the flow control element 8.

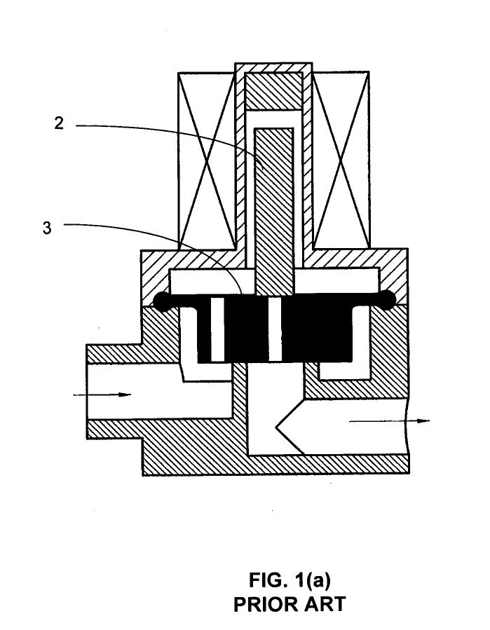

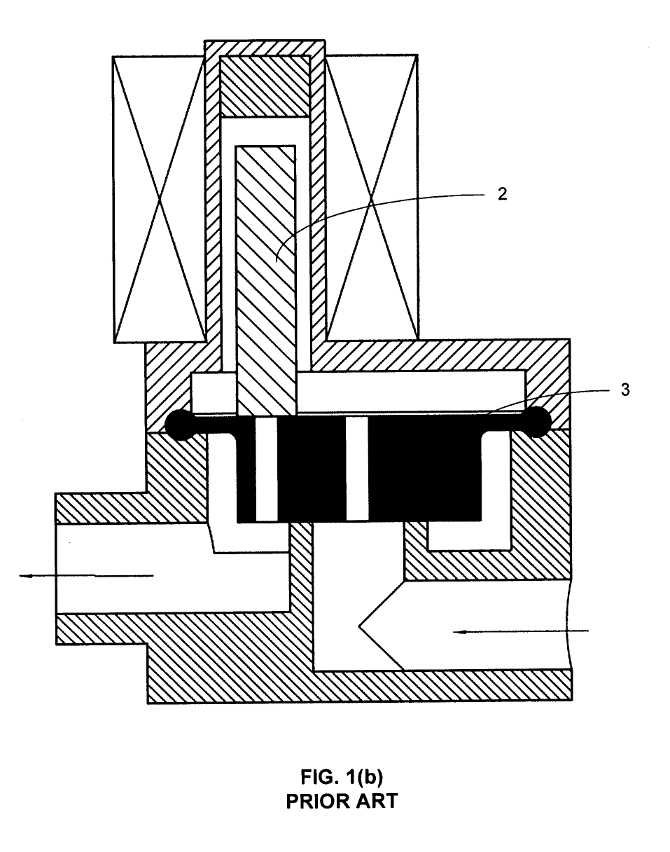

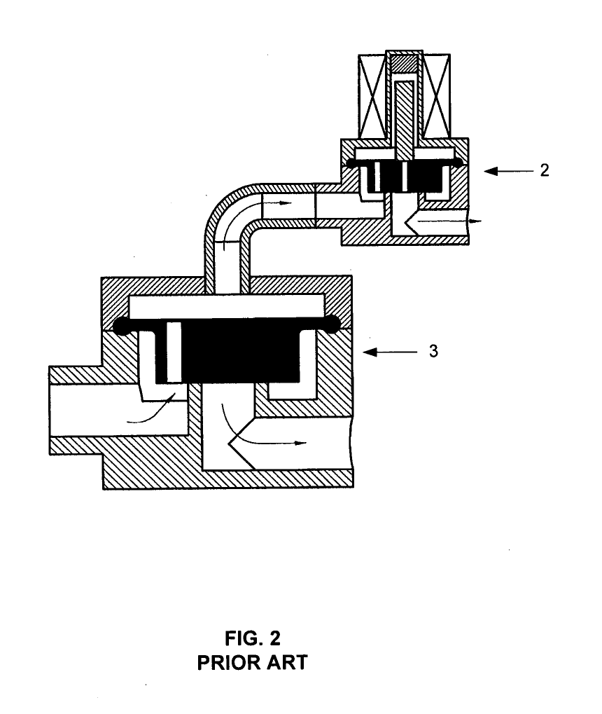

The uniqueness of the present invention resides in controlling the flow of fluid through an opening formed in a movable object by using only the energy needed to control said flow irrespective of the position of said object relative to the source of the controlling power, meaning that, unlike the conventional arrangement of FIG. 1.(a) and FIG. 1.(b), the relatively large movement of said valve member 3 has no effect on the amount of power needed to change the flow through said relief port 9. The consequential result of this is that the relatively small power required to open and close only relief port 9 is sufficient enough to initiate the large movement of said valve member 3. This is a significant distinguishing difference from the prior art.

FIG. 9 shows yet another alternative valve device arrangement to those shown in FIGS. 5 and 6, wherein the relief valve segment 13 is constructed from material/s such as dielectrics or bimetals and attached to valve member 3 in a manner which, when the energy state of said relief segment 13 is changed, the position of relief valve member 2 relative to the sealing surface of relief port 9 can also change to thereby control the operation of the devices.

In general, the manner in which said relief valve segment 13 controls the flow through said relief port 9 is irrelevant, as this will depend on the corresponding signal used and the interfacing profiles, states and conditions of the sealing surfaces. Also, the means of the power linkage 11 is not limited to resilient electric cables/conducting spring connection as is the case in this and some of the above alternative arrangements. But it could rather be pneumatic, hydraulic, or any other form of power linkage/transmission means. The means of ensuring that valve segment 13 has the tendency of maintaining the desired position relative to valve member 3 may include but is not limited to a spring/resilient material (which can also be used as said power linkage 11), click-on attachment thread, glue, interference fit, or manufactured as an integral part of valve member 3 depending on the mode of manufacture.

The valve member 3 is, as herein before described, preferably formed at least partially of a flexible material. As illustrated in the drawings, the central portion of the valve member 3 is preferably formed of a more rigid material. Hard rubber, operationally reinforced, perhaps with metal, is a suitable material. This allows for easy formation of the fluid passageway therein, which are not prone to the deterioration or tearing of the prior art orifices of the diaphragm components. The outer periphery of the valve device is preferably of a more flexible material to allow the member to move to and from the valve seat 6 whilst providing good fluid sealing properties therearound. A rubberised material is suitable.

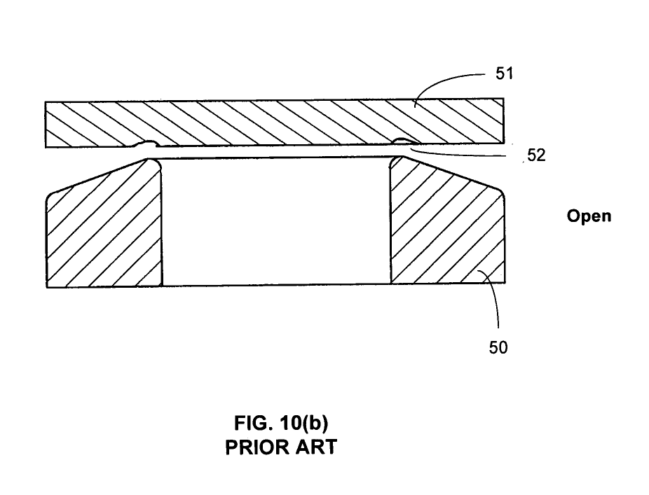

FIG. 10 illustrates a conventional arrangement of a valve seat known in the prior art. The conventional type of valve seat 50 is generally formed of a hard material, whereby a valve member 51, which is of somewhat softer material can therefore abut against the valve seat 50 as shown. As illustrated in FIG. 10b, after periods of extended use, permanent deformation tends to occur in the valve member 51 in the form of indentations 52 formed in the surface thereof due to constant pressure against the valve seat 50. Whilst this provides adequate sealing, it does tend to result in leakage when misalignment occurs.

In the valve device of the present invention, such as illustrated in FIGS. 4 and 5, it will be understood that as the resilient member 20 undergoes deformation from the position shown in FIG. 4 to the position shown in FIG. 5, the extremities of the protrusions 22 also cause some sliding movement of the resilient member 20. That is, the ends of the protrusions 22 slide inwards and outwards between the valve assembly components as the resilient member is drawn upwards and downwards.

In such an arrangement, if material such as described in FIG. 10 are used, then eventually leakage will occur due to misalignment of the various components.

The applicant has therefore proposed that a harder material be utilised for the valve member 51, and a softer component be used for the valve seat 52, such that minimal, if any permanent deformation of the valve member 51 is capable of occurring.

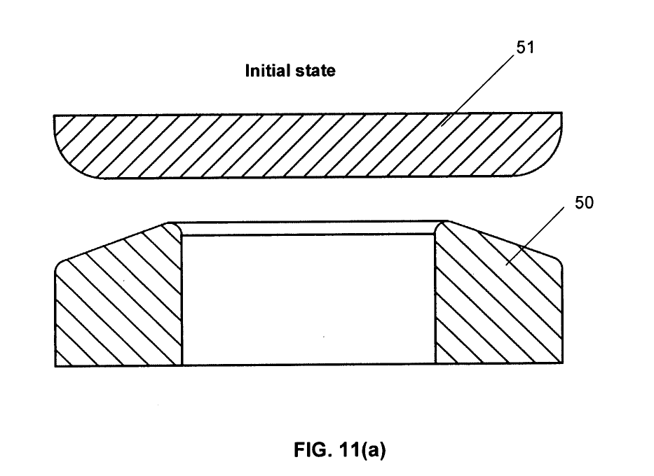

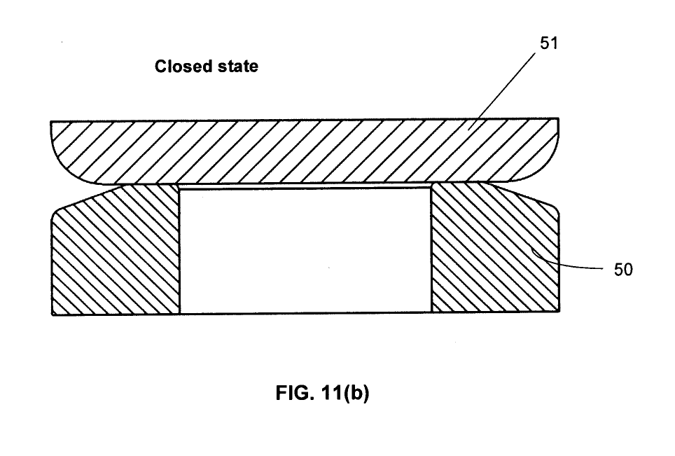

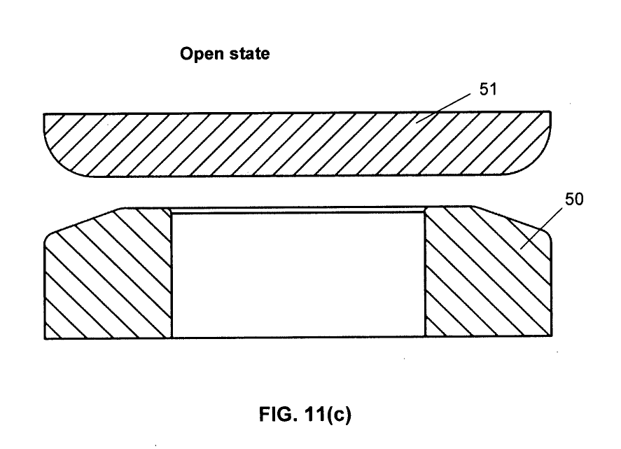

As illustrated in FIG. 11, the various components are shown in FIG. 11(a) in their initial state, in their closed state in FIG. 11(b), and in their open state in FIG. 11(c). It will be appreciated that any permanent deformation of the valve seat 50 does not result in any lesser sealing properties compared with the prior art arrangement in FIG. 10. That is, if the valve seat becomes slightly flattened or deformed then this would have no bearing on the sealing properties compared with the arrangement of FIG. 10.

However, the applicants proposed arrangement has significant advantages, when the valve member might undergo or is designed to have a sliding movement relative to the valve seat.

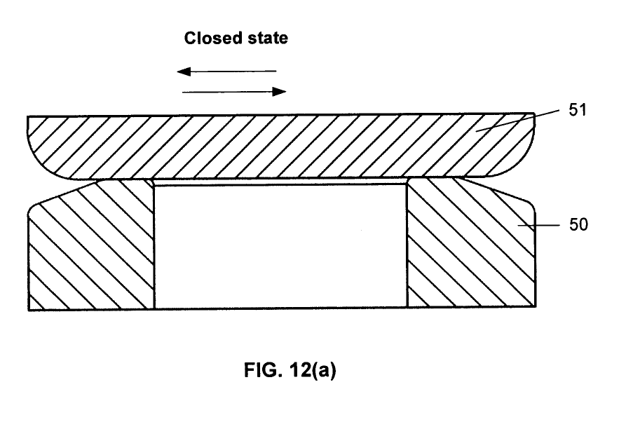

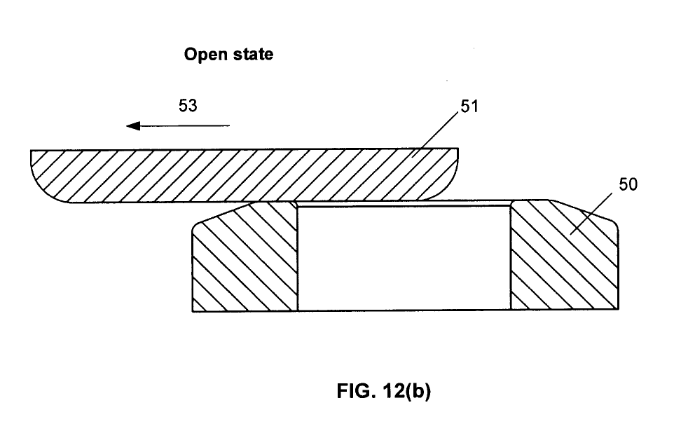

This is illustrated in FIG. 12, wherein it can be seen that as the valve member 51 undergoes sliding movement in the directions of arrows 53 relative to the valve seat 50 that any deformation of the valve seat 50 would also have no or minimal undue consequences on the effort needed for a sliding movement and the sealing of the valve, whereas, if the arrangement shown in FIG. 10 (prior art) were utilised, then such a sliding movement would require more effort to achieve and result in lesser sealing properties.

It will be appreciated that the arrangement shown in FIGS. 11 and 12 may be utilised in conjunction with the valve 1 shown in FIGS. 3 to 9, or with other valve devices. In essence, the valve device arrangement of the present invention is characterised in that at least the extremities of the valve seat is formed of a resilient material enabling at least some compression or deformation of the valve seat so it will be appreciated that this therefore provides improved sealing between the valve seat and the valve member and allows for achieving sliding movement with lesser effort regardless as to the type of movement which the valve member may undergo, including, but not limited to any one or combination of translational or rotational or sliding pivotal axial or other directional movement.

The present invention has been herein described with reference to particular preferred embodiments. It will however be readily understood to persons skilled in the art that numerous variations and modifications may be made to these preferred embodiments. All such variations and modifications should be considered to fall within the spirit and scope of the invention as broadly hereinbefore described.

1. A valve device including:
a fluid inlet;
a fluid outlet;
a main valve seat defining an aperture through which fluid may selectively flow from said inlet to said outlet;
a valve assembly, movable relative to said main valve seat between an open position of said valve in which fluid may flow from said inlet to said outlet, and, a closed position of said valve in which fluid flow is prevented;
a control chamber, at least a portion of the wall of which is formed by said valve assembly, such that the volume of said control chamber is variable depending upon the position of said valve assembly;
a fluid passageway, providing fluid communications between said fluid inlet and said control chamber.

2. A valve device as claimed in claim 1, wherein said valve assembly including:
a valve body, including a relief inlet, a relief valve seat defining a relief outlet, and an internal cavity; and
a relief valve member, movable within said internal cavity of said valve body between a first position whereby said relief valve member is moved apart from said relief valve seat such that fluid may flow from said relief inlet to said relief outlet, and, a second position whereby said relief valve member abut said relief value seat to prevent fluid flow through said relief outlet; and
a control means, to control the position of said relief valve member relative to said valve body of said valve assembly, and thereby, to control the movement of said valve assembly relative to said main valve seat between said open and closed positions.

3. A valve device as claimed in claims 1 and 2, wherein said valve body of said valve assembly is formed of one or more components joined together or kept at desirable position relative to each other by means of one or a combination of a spring-like/resilient biasing means, click-on attachment, thread, glue, heat-weld, ultrasonic-weld, or any other retaining means.

4. A valve device as claimed in claim 3 wherein said spring-like/resilient biasing means is also used to supply the signal and/or the power to actuate said control means.

5. A valve device as claimed in any one of claims 1 to 4, wherein said control means may or may not be an integral part of said valve assembly and includes any one or a combination of an electrical, mechanical, electromagnetic or other control means capable of initiating movement of said relief valve member relative to said valve body of said valve assembly.

6. A valve device as claimed in any one of claims 1 to 5, wherein said relief valve member is at least partly formed of resilient material such as to normally bias said relief valve member into either of said first or said second position.

7. A valve device as claimed in claim 6, wherein said relief valve member is normally biased into said second (closed) position and, to open said valve, said control means is activated to move said relief valve member away from said relief valve seat to initiate flow of fluid from said relief inlet to said relief outlet, whereby, once said flow is initiated, a change in fluid pressure effects said valve assembly to move away from said valve seat to open said valve and permit fluid to flow from said fluid inlet to said fluid outlet.

8. A valve device as claimed in claim 6, wherein said relief valve member is normally biased into said first (open) position and, to close said valve, said control means is activated to move said relief valve towards said relief valve seat to prevent flow of fluid from said relief inlet to said relief outlet, whereby, once said flow is prevented, a change in fluid pressure effects said valve assembly to move against said valve seat to close said valve and prevent flow of fluid from said fluid inlet to said fluid outlet.

9. A valve device as claimed in any one of claims 6 to 8, wherein said relief valve member includes at least one protrusion and preferably a plurality of protrusions, formed of resilient material, extending into contact with said valve body of said valve assembly, so as to bias said relief valve member relative to said valve body.

10. A valve device as claimed in any one of claims 1 to 9, further including:
a flow control element provided within said fluid passageway, to restrict the flow of fluid within said fluid passageway and substantially prevent the ingress of dirt or like particles from entering said fluid passageway and, if any does, the relative movement of said flow control element within said passageway cats to expel such particles from within said passageway.

11. A valve device arrangement including:
a valve seat defining an aperture through which fluid may flow when said valve device is in an open position; and,
a valve member adapted to move relative to said valve seat between, an open position whereby said valve member is at least partly displaced from said valve seat, and, a closed position whereby said valve member abuts said valve seat to prevent the flow of fluid through said aperture;
characterised in that, at least the extremities of said valve seat is formed of resilient material enabling at least some compression or deformation of said valve seat (to provide improved sealing between said valve seat and said valve member).

12. A valve device arrangement as claimed in claim 1, whereby movement of said valve member relative to said valve seat is any one or combination of translational, rotational, sliding pivotal, axial or other directional movement.

13. A valve component, adapted to be movably housed within a valve body between a first position whereby said valve component is moved apart from a valve seat, and a second position whereby said valve device abuts said valve seat, including at least one protrusion, and preferably a plurality of protrusions, formed of resilient material, extending into contract with said valve body so as to bias said valve component into at least one of said first or second positions relative to said valve body.
